(19) United States
(12) Patent Application Publication
(10) Pub. No.: US 2015/0246670 A1
(43) Pub. Date: Sep. 3, 2015

(54) VEHICLE CONTROL APPARATUS

(71) Applicants: Yukihiko Ideshio, Nisshin-shi (JP); Yuji Inoue, Nisshin-shi (JP); Yosuke Michikoshi, Miyoshi-shi (JP); Shintaro Matsutani, Toyota-shi (JP)

(72) Inventors: Yukihiko Ideshio, Nisshin-shi (JP); Yuji Inoue, Nisshin-shi (JP); Yosuke Michikoshi, Miyoshi-shi (JP); Shintaro Matsutani, Toyota-shi (JP)

(73) Assignee: TOYOTA JIDOSHA KABUSHIKI KAISHA, Toyota-shi, Aichi (JP)

(21) Appl. No.: 14/425,483

(22) PCT Filed: Sep. 21, 2012
(86) PCT No.: PCT/JP2012/074251

§ 371 Date: Mar. 3, 2015

(51) Int. Cl. B60W 20/00; B60W 10/02; B60W 10/06; B60K 6/48

(52) U.S. Cl. CPC B60W 20/40; B60K 6/48; B60W 10/02; B60W 10/026; B60W 10/06; B60W 2510/0275; B60W 2510/083; Y10S 903/93

(57) ABSTRACT

A vehicle control device includes an engine, an electric motor, a clutch, and a hydraulic power transmission device having a lockup clutch disposed on a power transmission path between the electric motor and drive wheels, the control device increasing the electric motor output torque while slip-engaging or releasing the lockup clutch when the engine is started by engaging the clutch during motor running performed by using only the electric motor as a drive force source for running with the clutch released and the lockup clutch engaged, the control device raising the clutch actual torque capacity toward clutch engagement after starting an increase in the electric motor output torque when a torque difference between a torque capacity of the lockup clutch and the output torque of the electric motor falls within a predetermined range as the torque capacity of the lockup clutch is reduced at the start of the engine.

### TECHNICAL FIELD

The present invention relates to a control device of a vehicle including a clutch disposed on a power transmission path between an engine and an electric motor and a fluid power transmission device with a lockup clutch disposed on a power transmission path between the electric motor and drive wheels.

### BACKGROUND ART

A vehicle is well-known that includes a clutch (e.g., referred to as a connecting/disconnecting clutch) disposed on a power transmission path between an engine and an electric motor and a fluid power transmission device with a lockup clutch disposed on a power transmission path between the electric motor and drive wheels. For example, this corresponds to a vehicle described in Patent Document 1. Such a vehicle is capable of motor running (EV running) performed by using only the electric motor as a drive force source with the connecting/disconnecting clutch released and engine running (EHV running) performed by using at least the engine as the drive force source with the connecting/disconnecting clutch engaged. If a start of the engine is determined during the EV running, the engine is started while the connecting/disconnecting clutch is engaged for switching to the EHV running. For example, in a technique proposed in Patent Document 1, when an input clutch (corresponding to the connecting/disconnecting clutch) is engaged to start the engine during the EV running with the lockup clutch engaged, an output torque of the electric motor is increased by an amount of a torque corresponding to a torque capacity of the input clutch (i.e., by an amount of an output torque of the electric motor going through the input clutch toward the engine as a torque rotationally driving the engine), and the lockup clutch is slip-engaged.

### PRIOR ART DOCUMENT

### Patent Documents

### Patent Document 1: Japanese Laid-Open Patent Publication No. 2011-16390

### Patent Document 2: Japanese Laid-Open Patent Publication No. 2006-306209

### SUMMARY OF THE INVENTION

### Problem to Be Solved by the Invention

When an engine is started during the EV running, the technique as described in Patent Document 1 increases an output torque of an electric motor to suppress temporary insufficiency of a drive torque and a shock attributable thereto. Additionally, a connecting/disconnecting clutch (corresponding to the input clutch of Patent Document 1) is engaged after determination of a predetermined slip state of a lockup clutch, thereby suppressing a shock associated with the engine start. However, a torque capacity of the connecting/disconnecting clutch (hereinafter, a connecting/disconnecting clutch torque) is not raised toward engagement of the connecting/disconnecting clutch until the slip state of the lockup clutch is determined in such a technique and, as a result, the engine is kept waiting until the start. Therefore, a certain time is required from an engine start request until the engine is actually started and, although the shock associated with the engine start is suppressed, the responsiveness of the engine start to the engine start request may deteriorate. On the other hand, for example, as described in Patent Document 2, a technique is well-known that when an engine start request is made, a torque capacity is reduced in a clutch disposed between an electric motor and drive wheels while the released connecting/disconnecting clutch is slipped at the same time, thereby rapidly starting the cranking of the engine. Although the responsiveness of the engine start is improved, however, such a technique may increase a start shock due to the cranking of the engine. At the engine start (particularly, at the engine start associated with an increase in a drive demand amount), it is desired to promptly start the engine while suppressing an engine start shock. The problem as described above is unknown and no proposal has hitherto been made on promptly starting an engine while suppressing an engine start shock at the time of starting the engine during the EV running with the lockup clutch engaged.

The present invention was conceived in view of the situations and it is therefore an object of the present invention to provide a control device of a vehicle capable of satisfying both suppression of a start shock and improvement in responsiveness of an engine start at the engine start during motor running with a lockup clutch engaged.

### Means for Solving the Problem

To achieve the object, the first aspect of the invention provides a control device of a vehicle including (a) an engine, an electric motor configured to output power for running and power required for starting the engine, a clutch disposed on a power transmission path between the engine and the electric motor, and a hydraulic power transmission device having a lockup clutch disposed on a power transmission path between the electric motor and drive wheels, the control device increasing an output torque of the electric motor while slip-engaging or releasing the lockup clutch when the engine is started by engaging the clutch during motor running performed by using only the electric motor as a drive force source for running with the clutch released and the lockup clutch engaged, (b) the control device raising an actual torque capacity of the clutch toward engagement of the clutch after starting an increase in output torque of the electric motor when a torque difference between a torque capacity of the lockup clutch and the output torque of the electric motor falls within a predetermined range as the torque capacity of the lockup clutch is reduced at the start of the engine.

### Effects of the Invention

Consequently, since the actual clutch torque can be raised toward the engagement of the clutch before the lockup clutch is actually put into the slip state, the engine can be started earlier than the case of starting the engine by raising a clutch torque after determining the slip state of the lockup clutch, based on a slip amount of the lockup clutch (e.g., a difference between a rotation speed of the electric motor and an output rotation speed of the hydraulic power transmission device). In this case, since the increase in output torque of the electric motor is started before the raising of the clutch torque when the torque difference is within the predetermined range, the torque going toward the lockup clutch is certainly set on the increase side to facilitate the shift of the lockup clutch to the slip state and to suppress a drop in a torque on the side of the drive wheels generated due to pull-in of torque associated with the release of the lockup clutch. This enables the suppression of the engine start shock generated by raising the clutch torque before the lockup clutch is put into the slip state. From another viewpoint, although the drop in the torque on the side of the drive wheels is easily made larger if the raise of the clutch torque is started earlier than the start of the increase in output torque of the electric motor, since the increase in output torque of the electric motor is started earlier than the start of the raise of the clutch torque, the drop in the torque on the side of the drive wheels is easily made smaller and the vehicle shock can be suppressed. Therefore, both the suppression of the start shock and the improvement in responsiveness of the engine start can be satisfied at the engine start during the motor running with the lockup clutch engaged.

The second aspect of the invention provides the control device of a vehicle recited in the first aspect of the invention, wherein the predetermined range is a range from zero to near zero defined in advance as a range of the torque difference before the lockup clutch is actually put into a slip state, and wherein the actual torque capacity of the clutch is raised when the torque difference is within the predetermined range. Consequently, the engine can certainly be started earlier as compared to the case of raising the clutch torque after determining the slip state of the lockup clutch. Additionally, the engine start shock can certainly be suppressed that is generated by raising the clutch torque before the lockup clutch is put into the slip state.

### BRIEF DESCRIPTION OF THE DRAWINGS

FIG. 1 is a diagram for explaining a general configuration of a power transmission device included in a vehicle to which the present invention is applied, and is a diagram for explaining a main portion of a control system in the vehicle.

FIG. 2 is a functional block diagram for explaining a main portion of the control function of an electronic control device.

FIG. 3 is an example of a lockup region diagram used when a lockup clutch is controlled.

FIG. 4 is an example of an EV/EHV region map used when switching between EV running and engine running is performed.

FIG. 5 is a flowchart for explaining a main portion of the control operation of the electronic control device, i.e., the control operation for satisfying both the suppression of the start shock and the improvement in responsiveness of the engine start at the engine start during the EV running with the lockup clutch engaged.

FIG. 6 is a time chart when the control operation depicted in the flowchart of FIG. is executed.

### MODE FOR CARRYING OUT THE INVENTION

In the present invention, preferably, the vehicle has an automatic transmission disposed on a power transmission path between the fluid power transmission device and the drive wheels. The automatic transmission is made up of an automatic transmission having the fluid power transmission device, or an automatic transmission having an auxiliary transmission. For example, this automatic transmission is made up of a known planetary gear type automatic transmission having rotating elements of plurality sets of planetary gear devices selectively coupled by engagement devices to achieve a plurality of gear stages in an alternative manner; a synchronous meshing type parallel two-shaft automatic transmission that is a synchronous meshing type parallel two-shaft transmission including pairs of always meshing change gears between two shafts and that has gear stages automatically switched by a hydraulic actuator; a so-called DCT (Dual Clutch Transmission) that is a synchronous meshing type parallel two-shaft automatic transmission and that is of a type having two systems of input shafts; a so-called belt type continuously variable transmission and a so-called toroidal type continuously variable transmission having gear ratios varied continuously in a stepless manner, etc.

Preferably, the engine is an internal combustion engine such as a gasoline engine and a diesel engine generating power from combustion of fuel, for example. The clutch disposed on the power transmission path between the engine and the electric motor is a wet or dry engagement device.

An example of the present invention will now be described in detail with reference to the drawings.

### EXAMPLE

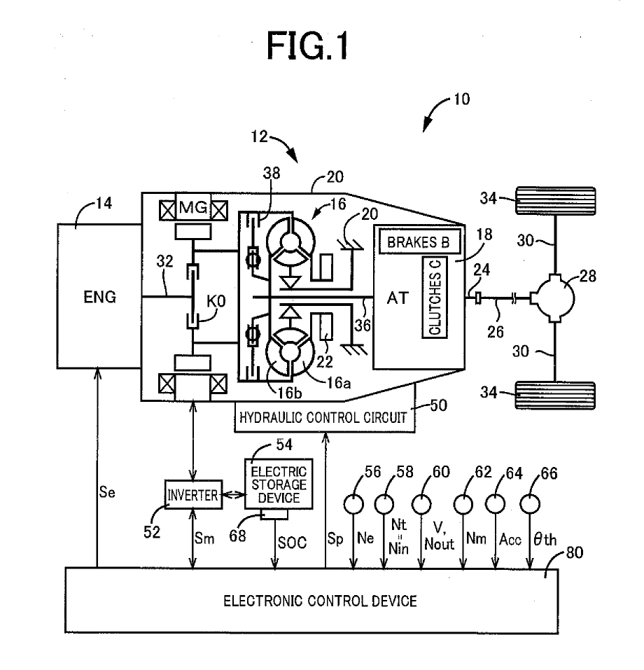

FIG. 1 is a diagram for explaining a general configuration of a power transmission device 12 included in a vehicle 10 to which the present invention is applied, and is a diagram for explaining a main portion of a control system for various types of control in the vehicle 10. In FIG. 1, the vehicle 10 is a hybrid vehicle including an engine 14 and an electric motor MG acting as drive force sources for running. The power transmission device 12 includes in a transmission case 20 acting as a non-rotating member, an engine connecting/disconnecting clutch K0 (hereinafter referred to as a connecting/disconnecting clutch K0), a torque converter 16, and an automatic transmission 18 in order from the engine 14 side. The power transmission device 12 also includes a propeller shaft 26 coupled to a transmission output shaft 24 that is an output rotating member of the automatic transmission 18, a differential gear device 28 coupled to the propeller shaft 26, a pair of axles 30 coupled to the differential gear device 28, etc. The power transmission device 12 configured as described above is preferably used in the vehicle 10 of the FR (front-engine rear-drive) type, for example. In the power transmission device 12, when the connecting/disconnecting clutch K0 is engaged, power (synonymous with a torque and a force if not particularly distinguished) of the engine 14 is transmitted from an engine coupling shaft 32 coupling the engine 14 and the connecting/disconnecting clutch K0, sequentially through the connecting/disconnecting clutch K0, the torque converter 16, the automatic transmission 18, the propeller shaft 26, the differential gear 28, the pair of the axles 30, etc., to a pair of drive wheels 34. As described above, the power transmission device 12 makes up a power transmission path from the engine 14 to the drive wheels 34.

The torque converter 16 is disposed on the power transmission path between the engine 14 (and the electric motor MG) and the drive wheels 34. The torque converter 16 is a fluid power transmission device transmitting power, which is input to a pump impeller 16a that is an input-side rotating member, via fluid to output the power from a turbine impeller 16b that is an output-side rotating member. The pump impeller 16a is coupled via the connecting/disconnecting clutch K0 to the engine coupling shaft 32 and is directly coupled to the electric motor MG. The turbine impeller 16b is directly coupled to a transmission input shaft 36 that is an input rotating member of the automatic transmission 18. The torque converter 16 includes a known lockup clutch 38 directly coupling the pump impeller 16a and the turbine impeller 16b. Therefore, the lockup clutch 38 is capable of achieving a mechanically directly-coupled state of the power transmission path from the engine 14 and the electric motor MG to the drive wheels 34. An oil pump 22 is coupled to the pump impeller 16a. The oil pump 22 is a mechanical oil pump rotationally driven by the engine 14 (and/or the electric motor MG) to generate a hydraulic oil pressure for providing shift control of the automatic transmission 18 and engagement/release control of the connecting/disconnecting clutch K0. The lockup clutch 38 is subjected to engagement/release control by a hydraulic control circuit 50 disposed in the vehicle 10 by using the oil pressure generated by the oil pump 22 as an original pressure.

The electric motor MG is a so-called motor generator having a function of a motor generating mechanical power from electric energy and a function of an electric generator generating electric energy from mechanical energy. The electric motor MG acts as a drive force source for running generating power for running in instead of the engine 14 that is a power source or along with the engine 14. The electric motor MG also performs operations such as generating electric energy through regeneration from the power generated by the engine 14 or a driven force input in the direction from the drive wheels 34 to accumulate the electric energy via an inverter 52 into an electric storage device 54. The electric motor MG is coupled to a power transmission path between the connecting/disconnecting clutch K0 and the torque converter 16 (i.e., operatively coupled to the pump impeller 16a) and power is mutually transmitted between the electric motor MG and the pump impeller 16a. Therefore, the electric motor MG is coupled to the transmission input shaft 36 of the automatic transmission 18 in a power transmittable manner without going through the connecting/disconnecting clutch K0.

The connecting/disconnecting clutch K0 is a wet multi-plate type hydraulic friction engagement device in which a plurality of friction plates overlapped with each other is pressed by a hydraulic actuator, for example, and is subjected to the engagement/release control by the hydraulic control circuit 50 by using the oil pressure generated by the oil pump 22 as an original pressure. In the engagement/release control, a torque capacity of the connecting/disconnecting clutch K0 (referred to as a K0 torque) is varied through pressure adjustment of a linear solenoid valve etc., in the hydraulic control circuit 50, for example. In an engaged state of the connecting/disconnecting clutch K0, the pump impeller 16a and the engine 14 are integrally rotated via the engine coupling shaft 32. On the other hand, in a released state of the connecting/disconnecting clutch K0, the power transmission between the engine 14 and the pump impeller 16a is disconnected. Since the electric motor MG is coupled to the pump impeller 16a, the connecting/disconnecting clutch K0 also acts as a clutch disposed on the power transmission path between the engine 14 and the electric motor MG to connect/disconnect the power transmission path.

The automatic transmission 18 makes up a portion of the power transmission path from the engine 14 and the electric motor MG to the drive wheels 34 to transmit the power from the drive force source for running (the engine 14 and the electric motor MG) toward the drive wheels 34. The automatic transmission 18 is a known planetary gear type multistage transmission including a plurality of hydraulic friction engagement devices such as clutches C and brakes B as engagement devices, for example, and having a plurality of shift stages (gear stages) selectively established through a shift made by engagement and release of the hydraulic friction engagement devices. In the automatic transmission 18, each of the hydraulic friction engagement devices is subjected to the engagement/release control by the hydraulic control circuit 50 to establish a predetermined gear stage depending on a driver's accelerator operation, a vehicle speed V, etc.

The vehicle 10 includes an electronic control device 80 including a control device of the vehicle 10 related to the engagement/release control of the connecting/disconnecting clutch K0 and the lockup clutch 38, for example. The electronic control device 80 includes a so-called microcomputer including a CPU, a RAM, a ROM, and an I/O interface, for example, and the CPU executes signal processes in accordance with a program stored in advance in the ROM, while utilizing a temporary storage function of the RAM, to provide various types of control of the vehicle 10. For example, the electronic control device 80 provides output control of the engine 14, drive control of the electric motor MG including regenerative control of the electric motor MG, the shift control of the automatic transmission 18, torque capacity control of the connecting/disconnecting clutch K0, torque capacity control of the lockup clutch 38, etc., and is configured separately as needed for the engine control, the electric motor control, the hydraulic control, etc. The electronic control device 80 is supplied with each of various signals (e.g., an engine rotation speed Ne that is a rotation speed of the engine 14, a turbine rotation speed Nt, i.e., a transmission input rotation speed Nin that is a rotation speed of the transmission input shaft 36, a transmission output rotation speed Nout that is a rotation speed of the transmission output shaft 24 corresponding to the vehicle speed V, an electric motor rotation speed Nm that is a rotation speed of the electric motor MG, an accelerator opening degree Acc corresponding to a drive demand amount to the vehicle 10 from a driver, a throttle valve opening degree θth of an electronic throttle valve, and a state of charge (charge capacity) SOC of the electric storage device 54) based on detection values from various sensors (e.g., an engine rotation speed sensor 56, a turbine rotation speed sensor 58, an output shaft rotation speed sensor 60, an electric motor rotation speed sensor 62, an accelerator opening degree sensor 64, a throttle sensor 66, and a battery sensor 68). The electronic control device 80 outputs, for example, an engine output control command signal Se for the output control of the engine 14, an electric motor control command signal Sm for controlling operation of the electric motor MG, and oil pressure command signals Sp for actuating an electromagnetic valve (solenoid valve) etc. included in the hydraulic control circuit 50 for controlling the hydraulic actuators of the connecting/disconnecting clutch K0, the lockup clutch 38, and the clutches C and the brakes B of the automatic transmission 18, to engine control devices such as a throttle actuator and a fuel supply device, the inverter 52, and the hydraulic control circuit 50, respectively.

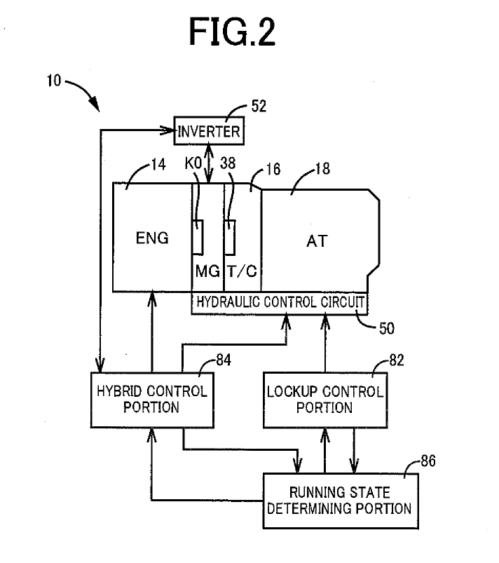

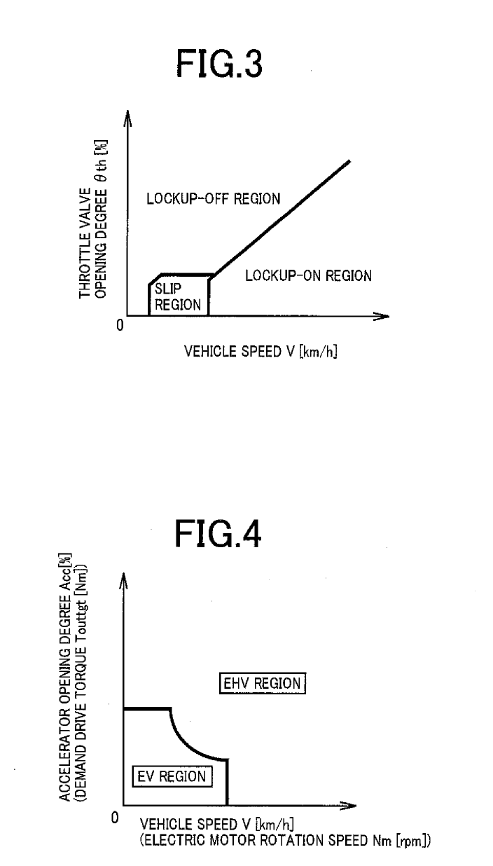

FIG. 2 is a functional block diagram for explaining a main portion of the control function of the electronic control device 80. In FIG. 2, a lockup control means, i.e., a lockup control portion 82 controls switching of actuation state of the lockup clutch 38 based on a vehicle state indicated by the actual vehicle speed V and the actual throttle valve opening degree θth from a preliminarily obtained and stored (i.e., predefined) relationship (a map, a lockup region diagram) having a lockup-off region in which the lockup clutch 38 is released, a slip region in which the lockup clutch 38 is slip-engaged, and a lockup-on region in which the lockup clutch 38 is completely engaged (i.e., the lockup clutch 38 is engaged without a slip, which is the same meaning as engaging the lockup clutch 38) in two-dimensional coordinates using the vehicle speed V and the throttle valve opening degree θth as variables as depicted in FIG. 3, for example. The lockup control portion 82 determines the actuation state of the lockup clutch 38 to be controlled based on the actual vehicle state from the lockup region diagram and outputs to the hydraulic control circuit 50 a command value (LU command pressure) Splu of an engagement oil pressure (lockup clutch pressure) of the lockup clutch 38 for switching to the determined actuation state. This LU command pressure Splu is one of the oil pressure command signals Sp.

A hybrid control means, i.e., a hybrid control portion 84, has a function as an engine drive control portion controlling drive of the engine 14 and a function as an electric motor operation control portion controlling the operation of the electric motor MG as a drive force source or an electric generator through the inverter 52, and provides control of the hybrid drive by the engine 14 and the electric motor MG through these control functions. For example, the hybrid control portion 84 calculates a demand drive torque Touttgt as the drive demand amount (i.e. a driver demand amount) to the vehicle 10 from a driver based on the accelerator opening degree Acc and the vehicle speed V and controls the drive force source for running so as to achieve output torque of the drive force source for running (the engine 14 and the electric motor MG) such that the demand drive torque Touttgt is acquired in consideration of a transmission loss, an accessory load, a gear stage of the automatic transmission 18, the charge capacity SOC of the electric storage device 54, etc. The drive demand amount can be implemented by using not only the demand drive torque Touttgt [Nm] at the drive wheels 34 but also a demand drive force [N] at the drive wheels 34, a demand drive power [W] at the drive wheels 34, a demand transmission output torque at the transmission output shaft 24, a demand transmission input torque at the transmission input shaft 36, a target torque of the drive force source for running (the engine 14 and the electric motor MG), etc. The drive demand amount can be implemented by simply using the accelerator opening degree Acc [%], the throttle valve opening degree θth [%], an intake air amount [g/sec] of the engine 14, etc.

Specifically, for example, if the demand drive torque Touttgt is within a range that can be covered solely by an output torque (MG torque) Tm of the electric motor MG, the hybrid control portion 84 sets a running mode to a motor running mode (hereinafter, EV mode) and performs motor running (EV running) using only the electric motor MG as the drive force source for running. On the other hand, for example, if the demand drive torque Touttgt is within a range that cannot be covered unless at least an output torque (engine torque) Te of the engine 14 is used, the hybrid control portion 84 sets the running mode to an engine running mode, i.e., a hybrid running mode (hereinafter, EHV mode), and performs engine running, i.e., hybrid running (EHV running), using at least the engine 14 as the drive force source for running.

FIG. 4 is a diagram of a relationship (EV/EHV region map) having an EV-EHV switch line dividing a region into a motor running region (EV region) and an engine running region (EHV region) defined in advance in two-dimensional coordinates using the vehicle speed V and the drive demand amount (e.g., the accelerator opening degree Acc) as variables. The hybrid control portion 84 performs the EV running if the vehicle state (e.g., the actual vehicle speed V and accelerator opening degree Acc) is within the EV region, for example, and performs the EHV running if the vehicle state is within the EHV region, for example.

If the EV running is performed, the hybrid control portion 84 releases the connecting/disconnecting clutch K0 to disconnect the power transmission path between the engine 14 and the torque converter 16 and causes the electric motor MG to output the MG torque Tm required for the EV running. On the other hand, if the EHV running is performed, the hybrid control portion 84 engages the connecting/disconnecting clutch K0 to connect the power transmission path between the engine 14 and the torque converter 16 and causes the engine 14 to output the engine torque Te required for the EHV running while causing the electric motor MG to output the MG torque Tm as an assist torque as needed.

For example, if a transition of the vehicle state is made from the EV region to the EHV region during the EV running or if the charge capacity SOC of the electric storage device 54 falls below a predetermined capacity defined in advance, the hybrid control portion 84 determines that an engine start request is made, switches the running mode from the EV mode to the EHV mode, and starts the engine 14 to perform the EHV running. In a method of starting the engine 14 by the hybrid control portion 84, for example, the engine 14 is started by engaging the released connecting/disconnecting clutch K0 (from another viewpoint, by rotationally driving the engine 14 by the electric motor MG). Specifically, if the engine start request is made, the hybrid control portion 84 outputs a command value (K0 command pressure) of an engagement oil pressure (K0 clutch pressure) of the connecting/disconnecting clutch K0 so as to acquire a K0 transmission torque Tk (corresponding to the K0 torque) for transmitting an engine start torque Tms that is a torque required for the engine start toward the engine 14, thereby raising the engine rotation speed Ne. When it is determined that the engine rotation speed Ne is raised to a predetermined rotation speed enabling a complete explosion, the hybrid control portion 84 starts the engine 14 by initiating engine ignition, fuel supply, etc. After the engine start, when it is determined that the engine rotation speed Ne increases through self-sustaining operation of the engine 14 to, and synchronizes with, the electric motor rotation speed Nm, the hybrid control portion 84 outputs the K0 command pressure (e.g., a maximum K0 command pressure corresponding to the maximum value of the K0 clutch pressure) so as to acquire the K0 transmission torque Tk for properly transmitting the engine torque Te toward the drive wheels 34 (e.g., so as to acquire the final K0 transmission torque Tk for completely engaging the connecting/disconnecting clutch K0).

Since the engine start torque Tms corresponds to the MG torque Tm going through the connecting/disconnecting clutch K0 toward the engine 14, the MG torque Tm going toward the drive wheels 34 is accordingly reduced. Therefore, at the start of the engine 14, the hybrid control portion 84 outputs to the inverter 52 a command for outputting the MG torque Tm of the magnitude acquired by adding the MG torque Tm required as the engine start torque Tms to the MG torque Tm during the EV running so as to suppress a drop in a drive torque Tout. As a result, for example, in addition to the MG torque Tin required for satisfying the demand drive torque Touttgt, the MG torque Tm required as the engine start torque Tms is output as an increased amount of the MG torque Tm (hereinafter referred to as an MG compensation torque Tmup) at the engine start. As described above, the electric motor MG also acts as the electric motor outputting the power required for the start of the engine 14.

If a gap is generated in rising timing or absolute value between the MG compensation torque Tmup and the actual K0 transmission torque Tk due to variations of components and variations of control (e.g., change in friction coefficient of the connecting/disconnecting clutch K0 and variations of responsiveness), the drive torque Tout may vary, resulting in a shock at the engine start (an engine start shock). Also when a gap is generated in the delivery of torque from the MG torque Tm to the engine torque Te, the drive torque Tout may vary, resulting in the engine start shock. Also when the torque variation associated with the explosion at the engine start is transmitted to the drive wheels 34, the engine start shock may occur. Particularly when the lockup clutch 38 is engaged, torque variation at the engine start is difficult to suppress as compared to when the lockup clutch 38 is slip-engaged or released, and the engine start shock may significantly occur.

Therefore, in this example, when the engine 14 is started by engaging the connecting/disconnecting clutch K0 during the EV running with the connecting/disconnecting clutch K0 released and the lockup clutch 38 engaged without a slip, the hybrid control portion 84 increases the MG torque Tm while the lockup control portion 82 temporarily slip-engages or releases the lockup clutch 38 (more preferably, slip-engages the lockup clutch 38), so as to suppress the engine start shock.

At the engine start (particularly, at the engine start associated with an increase in a drive demand amount), it is desired to rapidly start the engine while suppressing the engine start shock. However, if the engine 14 is started by increasing the MG torque Tm while the K0 transmission torque Tk is raised toward the engagement of the connecting/disconnecting clutch K0 after it is determined that the lockup clutch 38 is slip-engaged or released when the engine start request is made, the responsiveness of the engine start to the engine start request may deteriorate although the engine start shock is effectively suppressed. On the other hand, if the engine 14 is started by increasing the MG torque Tm while the K0 transmission torque Tk is raised toward the engagement substantially at the same time as a torque capacity of the lockup clutch 38 (hereinafter referred to as an LU torque Tlu) is reduced toward slip-engagement or release when the engine start request is made, the engine start shock may increase although the responsiveness of the engine start is improved.

Therefore, in this example, when a torque difference ΔTlm (=Tlu−Tm) between the LU torque Tlu and the MG torque Tm falls within a predetermined range in association with reduction of the LU torque Tlu at the start of the engine 14, the actual K0 transmission torque Tk is raised toward the engagement of the connecting/disconnecting clutch K0 after starting the increase in the MG torque Tm. The predetermined range is a range defined in advance as a torque range from immediately before to immediately after the LU torque Tlu goes below the MG torque Tm and is a range before the lockup clutch 38 is actually put into the slip state while the torque difference ΔTlm is in a range from zero to near zero. In other words, the predetermined range is a range from zero to near zero defined in advance as a range of the torque difference ΔTlm before the lockup clutch 38 is actually put into the slip state (i.e., immediately before being put into the slip state). Therefore, in this example, at the start of the engine 14, the actual K0 transmission torque Tk is raised toward the engagement of the connecting/disconnecting clutch K0 when the torque difference ΔTlm is within the predetermined range (i.e., before the lockup clutch 38 is actually put into the slip state). Before the actual K0 transmission torque Tk is raised, the increase in the MG torque Tm (i.e., MG torque compensation control of adding the MG compensation torque Tmup as torque compensation by the electric motor MG) is started.

Therefore, in this example, instead of waiting before raising the K0 transmission torque Tk until the lockup clutch 38 is slip-engaged or released at the start of the engine 14, the K0 transmission torque Tk is raised in the predetermined range immediately before the slip engagement of the lockup clutch 38, thereby more promptly starting the engine 14. In this case, the engine start shock may increase. Therefore, in this example, by increasing the MG torque Tm before the actual K0 transmission torque Tk rises so as to certainly set the torque going toward the lockup clutch 38 due to a gap between the MG compensation torque Tmup and the actual K0 transmission torque Tk on the increase side (to a positive value) in the predetermined range immediately before the slip engagement of the lockup clutch 38, the engine start shock is suppressed partially because the lockup clutch 38 is allowed to easily slip. Additionally, by certainly setting the torque going toward the lockup clutch 38 on the increase side so as to suppress a drop in the drive torque Tout generated due to pull-in of torque associated with the release of the lockup clutch 38, a vehicle shock at the engine start is suppressed. Therefore, the predetermined range is also a range of the torque difference ΔTlm defined in advance as a range in which the effect of damping the shock is easily acquired by certainly setting the gap between the MG compensation torque Tmup and the actual K0 transmission torque Tk on the increase side.

More specifically, returning to FIG. 2, a running state determining means, i.e., a running state determining portion 86 determines whether the vehicle 10 is during the EV running based on the control operation by the hybrid control portion 84, for example. The running state determining portion 86 also determines whether the hybrid control portion 84 determines that the engine start request is made during the EV running.

If the running state determining portion 86 determines that the vehicle 10 is during the EV running and that the engine start request is made (i.e., an engine start command is issued), for example, when the lockup clutch 38 is engaged without a slip, the lockup control portion 82 outputs to the hydraulic control circuit 50 a predetermined LU command pressure Splu for reducing the LU torque Tlu toward slip engagement of release of the lockup clutch 38, before start of the engine 14 by the hybrid control portion 84.

The running state determining portion 86 calculates an estimate value of the LU torque Tlu (an estimated LU torque Tlu′) based on the LU command pressure Splu of the lockup control portion 82 from a predefined relationship (a computing equation) between the LU command pressure Splu and the LU torque Tlu, for example. For example, during reduction of the LU torque Tlu (i.e. during LU torque reduction control) by the lockup control portion 82, the running state determining portion 86 calculates a torque difference ΔTlm′ (=Tlu′−Tm) between the estimated LU torque Tlu′ and a transmission input torque Tin, i.e., the MG torque Tm (corresponding to an electric motor torque command signal Sm), during the EV running with the lockup clutch 38 engaged without a slip. The running state determining portion 86 determines whether the torque difference ΔTlm′ is within the predetermined range.

The hybrid control portion 84 outputs a predetermined K0 command pressure to the hydraulic control circuit 50 to start the engine 14 such that the actual K0 transmission torque Tk can be raised toward engagement of the connecting/disconnecting clutch K0 when the running state determining portion 86 determines that the torque difference ΔTlm′ is within the predetermined range. In this engine start, the hybrid control portion 84 starts the MG torque compensation control such that the MG torque Tm is increased before the rise of the actual K0 transmission torque Tk when the running state determining portion 86 determines that the torque difference And is within the predetermined range.

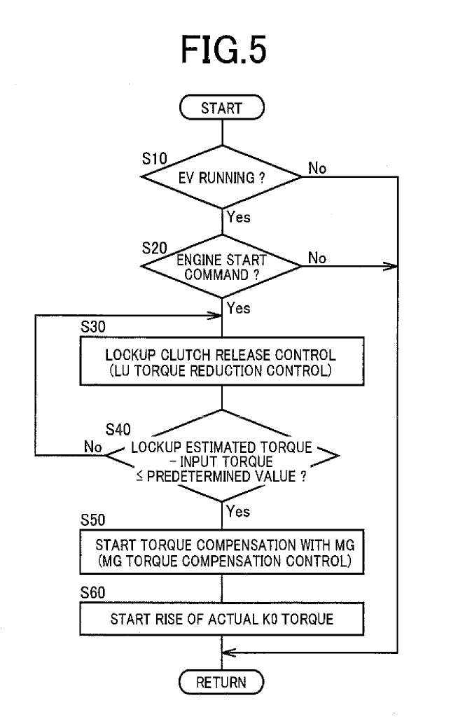

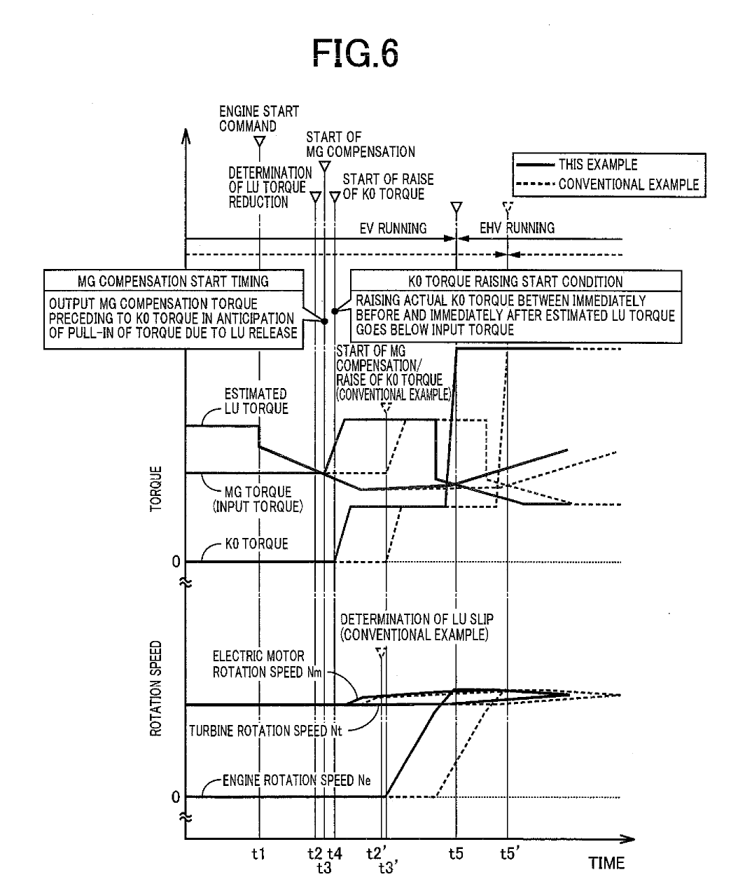

FIG. 5 is a flowchart for explaining a main portion of the control operation of the electronic control device 80, i.e., the control operation for satisfying both the suppression of the start shock and the improvement in responsiveness of the engine start at the engine start during the EV running with the lockup clutch 38 engaged, and is repeatedly executed with an extremely short cycle time, for example, on the order of a few msec to a few tens of msec. FIG. 6 is a time chart when the control operation depicted in the flowchart of FIG. 5 is executed.

In FIG. 5, first, at step (hereinafter, step will be omitted) S10 corresponding to the running state determining portion 86, it is determined whether the vehicle 10 is during the EV running, for example. If the determination of S10 is negative, this routine is terminated and, if affirmative, it is determined at S20 corresponding to the running state determining portion 86 whether the engine start command is output, for example. If the determination of S20 is negative, this routine is terminated and, if affirmative (at time t1 of FIG. 6), at S30 corresponding to the lockup control portion 82, for example, the LU torque reduction control is provided to reduce the LU torque Tlu toward slip engagement or release (after time t1 of FIG. 6). At S40 corresponding to the running state determining portion 86, for example, it is then determined whether the torque difference ΔTlm′ (=Tlu′−Tm) between the estimated LU torque Tlu′ and the transmission input torque Tin (i.e., the MG torque Tm) is within the predetermined range (after time t1 of FIG. 6). If the determination of S40 is negative, this routine is returned to S30 and, if affirmative (from time t2 to time t4 of FIG. 6), at S50 corresponding to the hybrid control portion 84, the MG torque compensation control is started such that the MG torque Tm is increased before the rise of the actual K0 transmission torque Tk (at time t3 of FIG. 6). At S60 corresponding to the hybrid control portion 84, the rise of the actual K0 transmission torque Tk is started toward engagement of the connecting/disconnecting clutch K0 (time t4 of FIG. 6).

The time chart of FIG. 6 depicts an example when the engine 14 is started during the EV running with the lockup clutch 38 engaged without a slip, for example. Solid lines of FIG. 6 indicate this example and broken lines indicate a conventional example. In the conventional example indicated by the broken lines of FIG. 6, when the engine start command is made (at time t1), after the slip state of the lockup clutch 38 is determined (at time t2′) because a slip amount Ns (=Nm−Nt) becomes equal to or greater than a predetermined slip, the MG torque Tm is increased while the K0 transmission torque Tk is raised so as to start the engine 14 (after time t3) and the EV running is switched to the EHV running (at time t5′). In contrast, in this example indicated by the solid lines of FIG. 6, when the engine start command is made (at time t1), the actual K0 transmission torque Tk is raised between immediately before and immediately after the estimated LU torque Tlu′ goes below the transmission input torque Tin (i.e., the MG torque Tm) (from time t2 to time t4) (i.e., before the lockup clutch 38 is actually put into the slip state) so as to start the engine 14 (after time t4) and the EV running is switched to the EHV running (at time t5). Therefore, in this example, the engine 14 is rapidly started as compared to the conventional example. In this start, the MG compensation torque Tmup is output precedingly to the rise of the actual K0 transmission torque Tk (after time t3) such that the torque going toward the lockup clutch 38 is certainly set on the increase side in anticipation of occurrence of pull-in of torque associated with the release of the lockup clutch 38. Therefore, in this example, partially because the lockup clutch 38 is allowed to easily slip due to the preceding output, the engine start shock is suppressed such that the shock is at least maintained on substantially the same level with the conventional example.

As described above, according to this example, since the actual K0 transmission torque Tk is raised when the torque difference ΔTlm (=Tlu−Tm) is within the predetermined range (before the lockup clutch 38 is actually put into the slip state), the engine 14 can be started earlier than the case of raising the actual K0 transmission torque Tk after determining the actual slip state of the lockup clutch 38. In this case, since the MG compensation torque Tmup is added before the raising of the K0 transmission torque Tk, the torque going toward the lockup clutch 38 is certainly set on the increase side to facilitate the shift of the lockup clutch 38 to the slip state and to suppress the drop in the drive torque Tout generated due to pull-in of torque associated with the release of the lockup clutch 38. This enables the suppression of the engine start shock generated by raising the actual K0 transmission torque Tk before the lockup clutch 38 is put into the slip state. From another viewpoint, although the drop in the drive torque Tout is easily made larger if the raise of the actual K0 transmission torque Tk is started earlier than the start of the MG torque compensation control, since the MG torque compensation control is started earlier than the start of the raise of the actual K0 transmission torque Tk, the drop in the drive torque Tout is easily made smaller and the vehicle shock can be suppressed. Therefore, both the suppression of the start shock and the improvement in responsiveness of the engine start can be satisfied at the engine start during the EV running with the lockup clutch 38 engaged.

According to this example, since the predetermined range is a range from zero to near zero defined in advance as a range of the torque difference ΔTlm from immediately before to immediately after the LU torque Tlu goes below the MG torque Tm, and the actual K0 transmission torque Tk is raised before the lockup clutch 38 is actually put into the slip state, the engine 14 can certainly be started earlier as compared to the case of raising the actual K0 transmission torque Tk after determining the actual slip state of the lockup clutch 38. Additionally, the engine start shock can certainly be suppressed that is generated by raising the actual K0 transmission torque Tk before the lockup clutch 38 is put into the slip state.

Although the example of the present invention has been described in detail with reference to the drawings, the present invention is applied in other forms.

For example, although the torque converter 16 is used as the fluid power transmission device in the example, another fluid power transmission device such as a fluid coupling without a torque amplification effect may be used instead of the torque converter 16.

Although the automatic transmission 18 is disposed in the vehicle 10 in the example, the automatic transmission 18 may not necessarily be disposed.

The above description is merely an embodiment and the present invention may be implemented in variously modified and improved forms based on the knowledge of those skilled in the art.

### NOMENCLATURE OF ELEMENTS

10: vehicle
14: engine
16: torque converter (fluid power transmission device)
34: drive wheels
38: lockup clutch
80: electronic control device (control device)
K0: engine connecting/disconnecting clutch (clutch)
MG: electric motor

1. A control device of a vehicle including an engine, an electric motor configured to output power for running and power required for starting the engine, a clutch disposed on a power transmission path between the engine and the electric motor, and a hydraulic power transmission device having a lockup clutch disposed on a power transmission path between the electric motor and drive wheels, the control device increasing an output torque of the electric motor while slip-engaging or releasing the lockup clutch when the engine is started by engaging the clutch during motor running performed by using only the electric motor as a drive force source for running with the clutch released and the lockup clutch engaged,
the control device raising an actual torque capacity of the clutch toward engagement of the clutch after starting an increase in output torque of the electric motor when a torque difference between a torque capacity of the lockup clutch and the output torque of the electric motor falls within a predetermined range as the torque capacity of the lockup clutch is reduced at the start of the engine.

2. The control device of a vehicle of claim 1, wherein
the predetermined range is a range from zero to near zero defined in advance as a range of the torque difference before the lockup clutch is actually put into a slip state, and wherein
the actual torque capacity of the clutch is raised when the torque difference is within the predetermined range.
